(19) United States
(12) Patent Application Publication
(10) Pub. No.: US 2011/0162255 A1
(43) Pub. Date: Jul. 7, 2011

(54) RODENT TRAP

(76) Inventor: Bertil Ingvar Burström, Angelholm (SE)

(21) Appl. No.: 12/736,645

(22) PCT Filed: Apr. 23, 2009
(86) PCT No.: PCT/SE2009/000206

§ 371 Date: Jan. 10, 2011

(30) Foreign Application Priority Data
Apr. 24, 2008 (SE) 0800944.1

(51) Int. Cl. A01M 23/24

(52) U.S. Cl. 43/90

(57) ABSTRACT

Trap for mice and rats comprising two legs (1, 2) with jaws (9, 10), where one leg (1) is horizontally moveable towards a fixed leg (2) via an intermediary link (5-8). The fixed leg rests on a base-plate (3) and has a cover-lid (4) at the top. The legs (1, 2) are fitted with grip handles (11, 12) at the opposite end. The jaws (9, 10) are acted upon by a draw spring (22) or spring clip (31), whose direction of force works near the fulcrum of the legs (1, 2) in the open position of the trap.

The closing movement is triggered by a bait-carrier (17, 18) with lever (16) fitted between the legs (1, 2), and which is flexibly suspended at the back. Its reverse movement is stopped by a stop device (26) behind the grip handle of the fixed leg. The bait-carrier (17, 18) can move in several directions, upwards, downwards and outwards. The bait can be mounted in and under the bait-carrier (17, 18, 28).

If the bait-carrier (17, 18) is moved from its position in any direction of release, the draw spring (22) is acted on, or on a pin of a crutch (19) fitted on the lever (16) on one of the legs with sliding surfaces (20, 21) inclined towards each other, which partially enclose the spring (22) or the pin. Emptying or loading is carried out in one operation.

### FIELD OF THE INVENTION

This invention concerns a trap whose aim is to attract rats, mice and similar vermin to try to reach or touch a bait that has been placed in the trap, and in so doing the trap is made to snap shut and kill the animal.

### BACKGROUND OF THE INVENTION

Rodents such as rats and mice are a perpetual problem for mankind. One reason is the difficulty in keeping buildings free from intruders as a slit of 7 mm in width is wide enough for mice. It is estimated that these vermin will exceed the human population and destroy food and material for enormous sums. They also spread infectious diseases and cause fires and damage as a result of gnawed-through electric cables and apparatuses, etc. The rodents try to get into dark corners and cavities and are lead to food by their olfactory and tactile organs. Biocides are insufficient and run the risk of harming other animals and human beings. Many feel that they cannot use traps due to the inconvenience, the risk of infection and the unpleasantness of loading and emptying them. Thus there is a need for an easily used, reliable, economical and environmentally friendly device to reduce the advance of the vermin.

### PRIOR ART

To eliminate rodents and similar vermin in farm buildings and industrial premises poisoned bait, traps and cages plus units that produce sound, light and vibrations are used. The animals are caught alive in cages but are stressed to death if the cage is not inspected at least twice a day. Seesaws where the animal is enticed into being tipped into a bucket, which is partly filled with a non-freezing liquid, lead to painful drowning and is therefore illegal. If the bucket is empty it must be at least 50 cm deep so that the resilient animals will not jump out.

Many traps are constructed for instant destruction. The authorities require that the vermin be quite dead within 30 seconds (ISO-standard 10990). There are many kinds of traps in patent literature. The most common ones are modifications of the trap which is made of bent wires on a wooden or metal base. Apart from the fact that these traps can hit the animal anywhere and injure it, these traps are difficult to set up with the result that they are often thrown away after use. This entails unnecessary resources and environmental pollution. One disadvantage of the modern design is that the bait is accessible also for small children and other animals. In order to eliminate this problem closed boxes have been produced as traps. One example of a patented trap with horizontal jaws is U.S. Pat. No. 4,070,787. Not even this one seems to comply with all reasonable requirements.

### Requests about a New Technology

A trap should be easy to empty with one hand without fingers getting near the animal. It should also be easy to set the trap to the right sensitivity without the risk of getting one's fingers caught. It is an advantage if the tripping mechanism has the choice of working in several directions so that different kinds of bait can be applied at the same time and be actuated in separate directions for quick effect. The mechanism must not be so sensitive to vibrations that the trap snaps shut while empty. The trap must function infallibly and not fail to destroy the animal immediately in the intended way. It is important that the trap is not dangerous to children, cats, dogs and birds, and that it does not hurt animals other than those for which the trap is intended. The bait should not be accessible and provide other vermin with nourishment after the trigger has been activated. Thus both the bait and clamp loop or clip and tripping mechanism should all be hidden inside a casing with a narrow opening. It is a further advantage if the trap is of low height so that it can be placed in drawers and under cupboards. Finally the trap should have a clean, attractive design with few parts to the lowest manufacturing and assembly costs.

### SHORT DESCRIPTION OF THE INVENTION

The set claims and requests are fulfilled as the said trap for mice, rats and similar vermin includes a leg, which preferably revolves horizontally connected to an opposite leg or impact via an intervening link, so that jaws or cutting-edge at the end of one of the legs in its outer position can form an opening for the mounted bait with a tripping mechanism between the legs and that the legs can be forced together by a spring, characterized by the force of the spring which is oriented so that the legs' torque is reduced when the jaws or the cutting-edges are moved to their outer position and that at least one of the legs has a cutting-edge at one of its ends and a grip handle at the opposite end, in the vicinity of which a grip can also be fitted on the other leg or impact.

The space between the legs is covered on the topside by a cover plate, which taking into consideration side forces and mass inertia should be part of the fixed leg and protrude from this. There is a base-plate under the fixed leg. In is advantageous if the base-plate protrudes somewhat outside the cutting-edges and the trap entrance opening so that the animal finds it difficult to move the trap. The outer edge of the base-plate can be supplied with warts or bosses to compensate for uneven floors. In contrast to the leg that is intended to stay still, the opposite movable leg can hover above the base-plate without any appreciable friction.

The outer contour of the legs can make up parts of a circle at least at the spring's working points for the greatest distance between these for best reproducible function. The legs can be held apart in different ways in their outer position. A preferred embodiment of the invention is that the legs can be separated from each other to beyond the dead centre or instantaneous centre towards an end stop where the power of the spring has just changed to an opening direction. The tensed spring or a peg or a stop device on the moveable leg, can then be actuated by a bait-carrier with a long lever and flexible suspension fitted between the legs, so that the moveable leg is driven back and snaps shut due to the power of the spring. It is an advantage if the lever's suspension is oscillating and articulated horizontally in two places near the gripping side of the legs, i e on the opposite side to the cutting-edge end. A stop device constructed on the lever with sliding surfaces or two or several opposite inclined surfaces, which partly enclose and are tangent to a section of the draw spring's envelope surface at the top and at the bottom, can then actuate the spring so that it moves and shuts the trap when the bait and bait-carrier are touched and pressed down or lifted upwards or pulled straight out by the animal. A pin or stop device that is tangent to the inside of the moveable leg in the same way has the same power transmission and closing function. Furthermore, by supplying the lever with a vertical articulation near the bait-carrier's oscillating suspension the spring tension can also be released when the bait-carrier is moved sideways to right or left. The same effect, although not as reliable, can be reached if the lever and for the rocker arm are shaped so that they are laterally flexible and pliant. In order to attain in this way five directions of motion for the bait-carrier it is necessary for the inclined surfaces to have a certain width along the tensed draw spring or the peg which is intended to actuate the movable leg.

In another design a blocking device locks the position between the fixed and the movable legs when they are in the position actuated by their outer spring tension, so that the movable leg can be disengaged by the bait-carrier's lever and then be snapped shut by the spring. Thereby no more than two tripping mechanism directions are achieved for the bait-carrier.

Another modification has a combined crossbar and barrier in behind the cutting-edges with an underlying bait-carrier. The crossbar has a flexible attachment at one end and rests on an abutting face at the other end, which the crossbar can slide away from under the effect of an average transverse force. The abutting face should be smooth and somewhat angled taking into account the angle of static friction. Alternatively the crossbar can be elastically flexible so that it can collapse, after which the legs are moved together by spring force.

The closing of the jaws can also be actuated by a C-shaped wire or spring blade with its points of application on the in- or outside of the cutting-edge legs and with its direction of force near the instantaneous centre when the trap has been opened in cocked position. That the spring's moment of force is neutralized is of importance for the sensitivity to touch of the bait-carrier and the crossbar. The spring can also be constructed on the outside as a protection against interference from children and household pets.

One variation of a trap according to the invention is configured so that the bait cannot be reached in any other way than via the opening between the cutting-edges, which open about 30 mm if the trap is planned for a mouse. On the other hand a person can lift the trap and get at the bait via an articulated hatch in the base-plate or the lid, and exchange the bait. Considering their similar size, long durability and resistance to water plus tastefulness the bait-carriers should preferably be adapted for almonds, hazel-nut kernels or block chocolate.

In the modification with cross barriers between the inside of the cutting-edge legs, the barrier should be constructed so that there is an opening between the barrier and the adjacent parts of a maximum of 7 mm through which a mouse can try and reach the bait. Naturally larger measurements are necessary for a trap intended for rats. As it is impossible to pass through such a narrow passage without the crossbar being subjected to side forces so that it is disturbed, the legs will close and the bait will scarcely be touched. The barrier in one form of embodiment is divided by a doubly-inclined joint, which makes it easier to dislodge it from its stable position so that the opposite barrier element can slide together and overlap due to the effect of the spring force. The barrier can also be constructed in another way, e g as an articulated overhead door in the underside of the cover plate with a device, which in the trap's cocked position, keeps the legs apart in their outer position.

The crossbar or barrier can also comprise a draw spring which, when it is contracted, can withstand static compressive forces but doubles over and collapses for small side-forces. Said spring can also have a flattened cross section where the orientation determines the desired direction of collapse.

In a simplified version of the invention the trap is mounted in such a way that a long-term bait is placed in an open box or directly on the floor after which the legs are opened so that the combined crossbar and barrier become bearing. The trap, which does not have a whole base-plate in this version, is then placed on the base so that the bait ends up in the intended space between the barrier and the vertical articulation. The vermin tries to reach the bait which is placed behind the barrier. If the barrier requires greater side-forces in order to double up the trap can move over the floor. For this reason it is an advantage to have a base-plate as the animal has to stand with its front paws on the base-plate to press away the hindrance that is blocking the way to the bait.

The idea of the invention allows for making the design low and closed with a lid and a narrow opening to the bait, which makes it almost impossible for small children, birds and household pets to come to any harm. The trap mainly comprises a few injection-moulded plastic components. Other advantages of the trap are that it is reliable and easy to mount and empty. Yet another advantage is that the spring force can be discharged quite near the dead centre before the moment of force of the spring increases in the opening direction, thanks to the great distance between the points of action. This means that the requisite tripping mechanism force for the bait-carrier, crossbar or barrier can be minimized without the trap becoming sensitive to rough treatment because of this.

### BRIEF DESCRIPTION OF THE FIGURES

The presented forms of embodiment of the invention are explained in detail with reference to FIGS. 1-5.

FIG. 1 shows a form of embodiment in oblique projection from above and from the front in its open position.

FIG. 2 shows a projected section of the form of embodiment without the cover-lid in open cocked position.

FIG. 3 shows the corresponding projected section in the closed position of the trap.

FIG. 4 shows a vertical section of the same form of embodiment in the open position of the trap.

FIG. 5 shows a side view of a trap fitted with a spring clip on the outside according to the invention, which also serves as a protection against interference.

### DESCRIPTION OF FORM OF EMBODIMENT

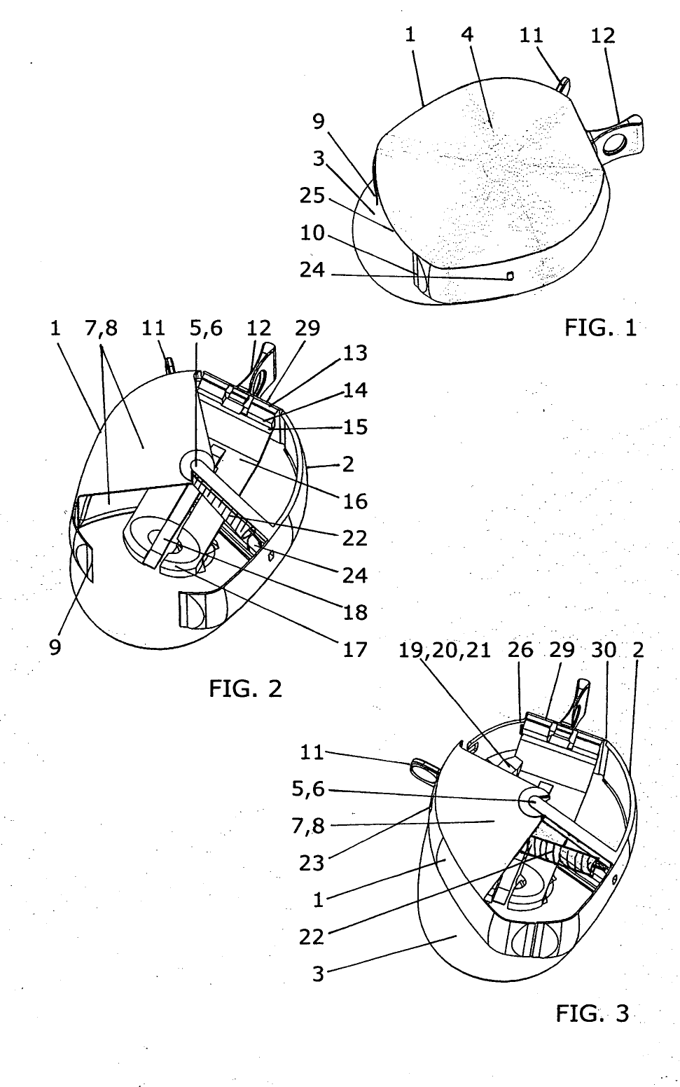

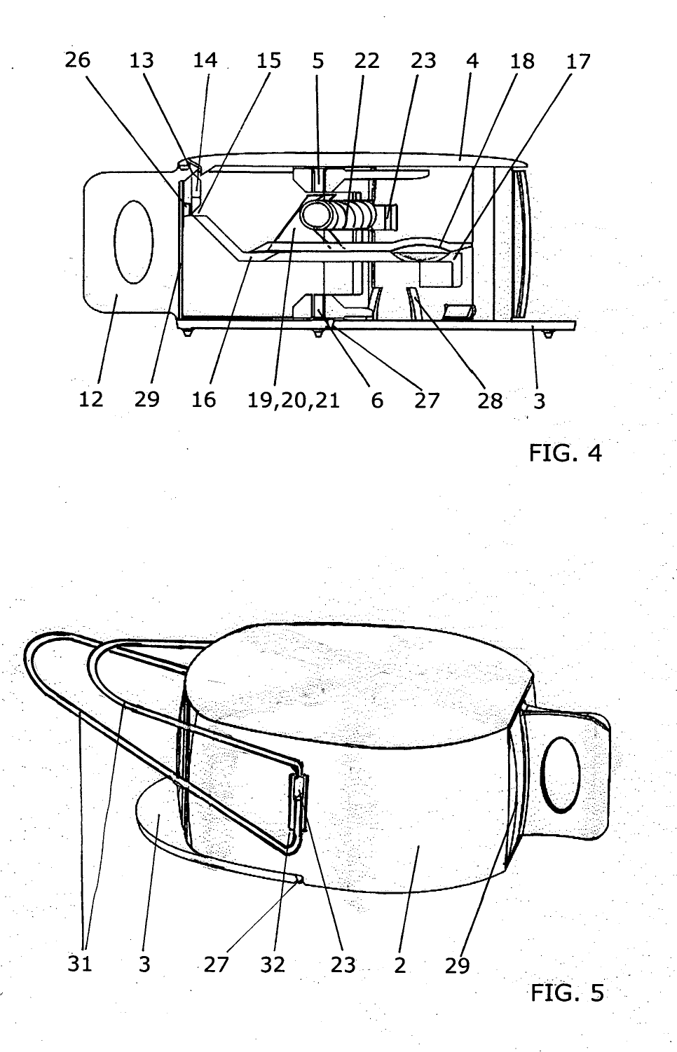

In FIGS. 1-4 a presentation of the form of embodiment of the invention is shown, which includes in this case a hinged moveable leg 1 and an impact or fixed leg 2, which in one and the same plastic unit are fitted with a base-plate 3 and a cover 4, between which leg 1 can turn towards, or away from, leg 2 via two pivot pins 5 and 6. These are extended over the base-plate 3 and under the cover 4 respectively and fit into two guiding crutches on the brackets 7 and 8 pertaining to leg 1. One end of leg 1 and leg 2 respectively is shaped like a sharp cutting-edge or jaws 9 and 10, while the other end of leg, 1, 2 respectively is fitted with a grip handle 11 and 12. Inside and near the fixed leg's 2 grip handle 12 and immediately under the cover 4 a horizontal hinge 13 is fitted, which continues with a downward-directed rocker arm 14, which in turn is fitted with a parallel hinge 15, from which a tongue or lever 16 runs as nearly as possible in a horizontal and central direction towards the legs' 1, 2 jaws 9 and 10, and ends inside these with a bait-carrier 17 with holding-down plate 18.

On one side of the lever's 16 topside near the hinge 15 there is a stop device 19 with one or several sliding surfaces with a two-way function in the form of inclined planes angled towards each other 20 and 21, which are constructed so that they partially enclose and touch a draw-spring 22. The angle of the inclined planes relative to the horizontal plane affects to a certain degree the sensitivity of the tripping mechanism function and can be 45 degrees. The spring 22 runs between the legs 1 and 2 and is exactly fixed in their inner sides in small oval mounting holes 23, 24 via the spring's 22 L-shaped ends. The attachment points 23, 24 are oriented so that the direction of force of the spring 22 passes on the other side adjacent to the instantaneous centre and dead centre of the leg 1. The moment of force is slightly opened, at the same time as the space between the jaws' cutting-edges 9, 10 forms a suitable entry opening for the vermin in question. The entry opening 25 of the trap is controlled by the opening of the legs 1 and 2 whose movements are operated with one hand via the grip handles 11 and 13, and are blocked by a stop device 26 situated in the area inside the grip handles 12 at the hinge joint 15 and the rocker arm 14. The stop device 26 can alternatively comprise a screw adjustable from the outside.

When the bait in the bait-carrier 17 is touched by a downward or upward force or is pulled straight out, the stop device 19 actuates the spring 22 and moves this in its latitudinal direction, so that the moment of force changes to an accelerating shutting moment.

Thanks to the fact that the base-plate 3 and the cover-lid 4 between the legs 1,2 where the bait-carrier 17 is situated behind the jaws 9 and 10, the space is inaccessible to the vermin except via the opening between the cutting-edges 9, 10 and the base-plate 3 and the cover-lid 4. The space between the cutting-edges 9, 10 for mice of about 30 mm in the trap's open, cocked position and a similar, inner vertical measure, make the trap almost harmless for small children and birds, cats and dogs. In order to achieve a quick execution of the vermin the cutting-edges 9, 10 on the respective legs 1, 2 are preferably fitted so that they overlap each other in an overbite when the trap has snapped shut. This design complies with the animal protection requirement for instantaneous death by snapping the vermin's neck and spine.

In order to simplify the exchange of the bait the base-plate 3 is partially divided by a hinge 27 between the pivot pins 5, 6 and the jaws 9, 10, so that this segment of the base-plate 3 can be lowered after which it can be snapped onto leg 2. In order for the trap to attract vermin faster a trap can have space for several baits at the same time according to the invention. Thus, for example, several spikes 28 for a hazelnut kernel or a bit of chocolate can be fitted on to the base-plate 3 under the bait-carrier 17. Since the bait-carrier 17 with its lever 16 has three tripping mechanism directions the trap snaps shut whether the animal nibbles at the bait in the carrier 17 or not or tries to squeeze under it to get at the bait underneath.

The legs 1, 2 and the base-plate 3 and the cover-lid 4 are designed so that, in principle, they can be inscribed within a circle with the pivot pins 5 and 6 in the centre of the solid of revolution. The round shape has the advantage of leaving space for an extra long spring with higher moment and more precise tripping mechanism function and also conceals the change of shape of the trap from an open to a shut position.

It is an advantage from the financial aspect of production and assembly that the number of plastic components be reduced to a minimum. This can be achieved if the back piece 29 at the hinge 13 can be made to rotate outwards by means of a vertical hinge 30 so that the whole of the lever 16 with its directional devices 13-15 and the bait-carrier 17 end up outside the outer contours of the moulding tools for the base and cover plates 3, 4 respectively. After the injection moulding everything can then be swung inwards to a snap-locked position against the base and the cover plates 3, 4, after one of the ends of the spring 22 has been applied, after which the revolving leg 1 is directed in towards its hinge parts 5-8, and is locked with the aid of the force at the end of the spring 22, which is fastened in hole 24 on the inside of the fixed leg 2.

FIG. 5 shows how a trap for mice and rats according to the invention can be fitted with a spring clip 31 with an integrated interference protection function for prevention of accidents as a result of unauthorized actuation of bait and jaws. Each leg 1, 2 is fitted on the outside with depressions or spring positioning 32 for the spring clip 31 with an orientation so that the moment of the spring force is as good as neutralized or balanced at the dead centre or instantaneous centre, and that the forward extension of the spring clip 31 at the upper edge of the jaws 9, 10 becomes almost symmetrical in the open, cocked position of the trap. The bait-carrier's lever with its stop device 19 and its inner inclined planes 20, 21 exert an influence here on a pin or peg on the inside of the moveable leg 1 instead of on the draw spring 22. This spring device has the advantage of being simpler to assemble and therefore produces a less expensive end product.

### EXAMPLES OF MODIFICATIONS OF THE INVENTION IDEA

An expert would realize that the devices according to the invention idea can be combined and configured in many different ways. As mentioned above it is satisfactory with a single leg if its edge is configured to tackle a hard impact with spring force, and where the other constructions for bait, tripping mechanism or barrier correspond approximately to the description above. A trap according to the invention can also be configured to stand against or hang on a wall alternatively be designed to stand on one side with the direction of impact of the trap approximately vertical. For voles and moles the legs, base plate and cover-lid can be configured with their cutting-edges also in a sideways or latitudinal direction.

What is claimed is:

1. a trap for mice, rats and similar vermin comprising a leg, preferably revolving horizontally connected to an opposite leg or an impact via an intervening link so that a jaw or cutting-edge at the end of one of the legs in its outer position can together with the opposite cutting edge, impact or leg, form an opening for the mounted bait and tripping mechanism between the legs and that the legs can be forced together by a spring, characterized by the impact force of the spring which is oriented so that the torque of the legs is reduced when the legs are moved to their outer position and that at least one of the legs has a cutting-edge at one of its ends and a grip handle at the opposite end, near which a grip handle can also be fitted on the other leg or impact.

2. Trap according to claim 1, characterized by the legs and the space between being covered underneath wholly or partially by a base-plate and above by a cover-lid, which are fitted with articulated mechanisms for the legs, and that the outer parts in connection with the point of action of the spring, with regard to their outer contour, inscribed in a circle to achieve maximum spring movement of an inner draw spring or a spring clip fitted onto the outside.

3. Trap according to claim 1 or 2, characterized by a bait-carrier fitted inside the entrance opening between the legs at the far end of a tongue or lever, which is flexibly hung up at the lever's rear end in connection to the legs' or the stop bolt's grip handle.

4. Trap according to claim 3, characterized between the legs by a fitted bait-carrier with lever being hinged at the back with two hinges above each other with a rocker arm in between, where the lever near the lower hinge point comprises a stop device, which preferably includes one or several inclined surfaces, angled towards each other, which partially enclose and are tangent to a draw spring fitted between the legs, or alternatively are tangent to a peg or stop device pertaining to the moveable leg, and that its opening movement is limited by a fixed or adjustable stop device, which acts on that part of the rocker arm, which is adjacent to the lever.

5. Trap according to claim 4, characterized by the bait-carrier's lever being flexible in a horizontal transverse direction due to the rocker arm and the lever having an elastic design or that the lever is fitted with a vertical hinge near the rocker arm and that the inclined surfaces have an extension in the draw spring's longitude, which exceeds the spring's diameter or the pivot's area of contact.

6. Trap according to some of the claims 2-5, characterized by the trap's base-plate being fitted with a bait-carrier, placed under an upper bait-carrier with the lever belonging to it, and that the adjacent part of the base-plate comprises a flexible hinge to enable it to be folded away and to facilitate the possibility of mounting suitable baits.

7. Trap according to some of the claims 3-6, characterized by the moveable leg comprising a ratchet, which together with the corresponding ratchet on the lever of the bait-carrier detains the leg in its open position when acted upon by the spring force, which can be released for the closing movement if the bait-carrier is affected and its position altered so that the lever's ratchet is released from the ratchet on the moveable leg.

8. Trap according to some of the claims 3-7, characterized by part of the base-plate protruding outside the cutting-edges so that the vermin must step onto the base-plate with its forelegs to reach something of the baits in or under a bait-carrier, and that the spring is complemented or replaced by a spring clip acting outside the legs, which is also constructed as a protection against interference in front of the trap's entrance opening.

9. Trap according to some of the claim 1, 2 or 8, characterized by the space between the legs behind the jaws and in front of the pivot centre being blocked at least partially by a transverse bar or barrier, which is fitted with a device to keep the legs temporarily open and apart against the action of a spring pressing against the legs.

10. Trap according to some of the claim 1, 2, 8 or 9, characterized by the barrier being so constructed as to have its form and position changed by the vertically or horizontally directed forces onto the said barrier and that the ability of the barrier to keep the cutting-edges of the legs apart can be eliminated due to similar forces.
